(19) United States
(12) Patent Application Publication
(10) Pub. No.: US 2026/0021389 A1
(43) Pub. Date: Jan. 22, 2026

(54) VIRTUAL VEHICLE CONTROL METHOD AND APPARATUS, TERMINAL DEVICE, AND STORAGE MEDIUM

(71) Applicant: Tencent Technology (Shenzhen) Company Limited, Shenzhen (CN)

(72) Inventors: Haosheng Xue, Shenzhen (CN); Jinlong Tu, Shenzhen (CN); Zhipeng Luo, Shenzhen (CN)

(21) Appl. No.: 19/339,744

(22) Filed: Sep. 25, 2025

Related U.S. Application Data
(63) Continuation of application No. 18/754,508, filed on Jun. 26, 2024.
Application No. 18/754,508 is a continuation of application No. PCT/CN2023/087409, filed on Apr. 10, 2023.

(30) Foreign Application Priority Data
May 20, 2022 (CN) 202210557037.9

(51) Int. Cl. A63F 13/422; A63F 13/533; A63F 13/57; A63F 13/803

(52) U.S. Cl. CPC A63F 13/422; A63F 13/533; A63F 13/57; A63F 13/803; A63F 2300/64; A63F 2300/8017

(57) ABSTRACT

A virtual vehicle control method, apparatus, terminal device, and storage medium are provided. The method includes: displaying a virtual vehicle in a flying state, the flying state being a state in which the virtual vehicle is not in contact with a ground of a virtual environment; controlling the virtual vehicle to change from the flying state to a landing state in which the virtual vehicle is in contact with the ground of the virtual environment; controlling the virtual vehicle to move forward at a decelerating rate when the vehicle is in a throttle released state at a landing moment at which the flying state is changed to the landing state; and within a first duration counted from the landing moment and in response to detecting an operation for charging prior to detecting a first operation for controlling the virtual vehicle to accelerate, controlling the virtual vehicle to move forward at an accelerating rate with an additional power.

### RELATED APPLICATIONS

This application is a continuation of U.S. application Ser. No. 18/754,508, filed Jun. 26, 2024, which is a continuation of PCT Application No. PCT/CN2023/087409, which claims priority to Chinese Patent Application No. 202210557037.9, filed on May 20, 2022 and entitled “VIRTUAL VEHICLE CONTROL METHOD AND APPARATUS, TERMINAL DEVICE, AND STORAGE MEDIUM”, both of which are incorporated herein by reference in their entirety.

### FIELD OF THE TECHNOLOGY

Aspects described herein relate to the field of Internet and computer technologies, and in particular, to a virtual vehicle control method and apparatus, a terminal device, and a storage medium.

### BACKGROUND

In vehicle racing-type computer games, a user may control a virtual vehicle to perform operations such as turning, drifting, and flying.

In a related art, a slipping phenomenon occurs for a certain duration after the virtual vehicle flies and lands, the user controls the vehicle to move after the slipping of the virtual vehicle ends, and a control manner of the virtual vehicle may be overly simplistic, resulting in poor authenticity.

### BRIEF SUMMARY

Aspects of the disclosure provide a virtual vehicle control method and apparatus, a terminal device, and a storage medium, and richness and authenticity of a control manner of a virtual vehicle can be improved. Various technical solutions and aspects include the following:

According to an aspect described herein, a virtual vehicle control method is provided. The method may be performed by a terminal device, and the method may include:
displaying a virtual vehicle in a flying state, the flying state being a state in which the virtual vehicle is not in contact with a ground of a virtual environment;
controlling the virtual vehicle to change from the flying state to a landing state, the landing state being a state in which the virtual vehicle is in contact with the ground of the virtual environment;
controlling the virtual vehicle to move forward at a decelerating rate when the virtual vehicle is in a throttle released state at a landing moment of the virtual vehicle, the landing moment being a moment at which the flying state is changed to the landing state; and
within a first duration counted from the landing moment and in response to detecting an operation for charging prior to detecting a first operation for controlling the virtual vehicle to accelerate, controlling the virtual vehicle to move forward at an accelerating rate with an additional power.

According to one or more other aspects, a virtual vehicle control method is provided. The method may be performed by a terminal device, and the method may include:
displaying a virtual vehicle in a flying state, the flying state being a state in which the virtual vehicle is not in contact with a ground of a virtual environment;
controlling the virtual vehicle to change from the flying state to a landing state, the landing state being a state in which the virtual vehicle is in contact with the ground of the virtual environment;
controlling the virtual vehicle to move forward at a decelerating rate when the virtual vehicle is in a throttle released state at a landing moment of the virtual vehicle, the landing moment being a moment at which the flying state is changed to the landing state; and
controlling the virtual vehicle to move forward at an accelerating rate with an additional third power in response to an operation for a charge control and a first operation for a throttle control in first duration from the landing moment, the operations for the charge control and the throttle control being triggered sequentially.

According to one or more further aspects, a virtual vehicle control apparatus is provided. The apparatus may include:
a vehicle display module, configured to display a virtual vehicle in a flying state, the flying state being a state in which the virtual vehicle is not in contact with a ground of a virtual environment; and
a vehicle control module, configured to control the virtual vehicle to change from the flying state to a landing state, the landing state being a state in which the virtual vehicle is in contact with the ground of the virtual environment;
the vehicle control module, further configured to control the virtual vehicle to move forward at a decelerating rate when the virtual vehicle is in a throttle released state at a landing moment of the virtual vehicle, the landing moment being a moment at which the flying state is changed to the landing state; and
the vehicle control module being further configured to control the virtual vehicle to move forward at an accelerating rate with an additional first power in response to a first operation for a throttle control in first duration from the landing moment.

According to an aspect, a virtual vehicle control apparatus is provided. The apparatus may include:
a vehicle display module, configured to display a virtual vehicle in a flying state, the flying state being a state in which the virtual vehicle is not in contact with a ground of a virtual environment; and
a vehicle control module, configured to control the virtual vehicle to change from the flying state to a landing state, the landing state being a state in which the virtual vehicle is in contact with the ground of the virtual environment;
the vehicle control module, further configured to control the virtual vehicle to move forward at a decelerating rate when the virtual vehicle is in a throttle released state at a landing moment of the virtual vehicle, the landing moment being a moment at which the flying state is changed to the landing state; and
the vehicle control module being further configured to control the virtual vehicle to move forward at an accelerating rate with an additional third power in response to an operation for a charge control and a first operation for a throttle control in first duration from the landing moment, the operations for the charge control and the throttle control being triggered sequentially.

According to one or more aspects, a terminal device is provided. The terminal device includes a processor and a memory, the memory has at least one program (such as computer-readable instructions) stored therein, and the at least one program is loaded and executed by the processor to implement the virtual vehicle control method.

According to one or more aspects, a computer-readable storage medium is provided. The computer-readable storage medium has at least one program (such as computer-readable instructions) stored therein, and the at least one program is loaded and executed by a processor to implement the virtual vehicle control method.

According to one or more aspects, a computer program product is provided. The computer program product includes a computer program, and the computer program is stored in a computer-readable storage medium. A processor of a computer device reads the computer program from the computer-readable storage medium, and the processor executes the computer program, to cause the computer device to implement the virtual vehicle control method.

In a flying and landing process of the virtual vehicle, a user may release a throttle when the virtual vehicle flies and subsequently perform a first operation for the throttle control after the virtual vehicle lands, to implement a landing speed-up trick for the virtual vehicle. Additional power can be obtained for the virtual vehicle for a certain duration, and richness of a control manner of the virtual vehicle may be improved. In addition, by adding the above operation logic, a landing speed-up process of a vehicle in the real world can be simulated, and authenticity of the virtual vehicle may be improved in a control process.

In addition, additional power for a certain duration brought by the landing speed-up trick of the virtual vehicle may partially or entirely cancel an impact of the virtual vehicle flying and landing at a vehicle speed. This improves user experience of controlling the virtual vehicle.

### BRIEF DESCRIPTION OF THE DRAWINGS

FIG. 1 is a schematic diagram of an example interface according to one or more aspects described herein.

FIG. 2 is a schematic diagram of an example interface according to one or more aspects described herein.

FIG. 3 is a schematic diagram of an example interface according to one or more aspects described herein.

FIG. 4 is a schematic diagram of an example implementation environment according one or more aspects described herein.

FIG. 5 is a flowchart of an example virtual vehicle control method according to one or more aspects described herein.

FIG. 6 is a flowchart of an example virtual vehicle control method according to one or more aspects described herein.

FIG. 7 is a flowchart of an example virtual vehicle control method according to one or more aspects described herein.

FIG. 8 is a flowchart of an example virtual vehicle control method according to one or more aspects described herein.

FIG. 9 is a flowchart of an example virtual vehicle control method according to one or more aspects described herein.

FIG. 10 is a flowchart of an example virtual vehicle control method according to one or more aspects described herein.

FIG. 11 is a block diagram of an example virtual vehicle control apparatus according to one or more aspects described herein.

FIG. 12 is a block diagram of an example virtual vehicle control apparatus according to one or more aspects described herein.

FIG. 13 is a block diagram of an example virtual vehicle control apparatus according to one or more aspects described herein.

FIG. 14 is a block diagram of an example virtual vehicle control apparatus according to one or more aspects described herein.

FIG. 15 is a block diagram of an example terminal device according to one or more aspects described herein.

### DETAILED DESCRIPTION

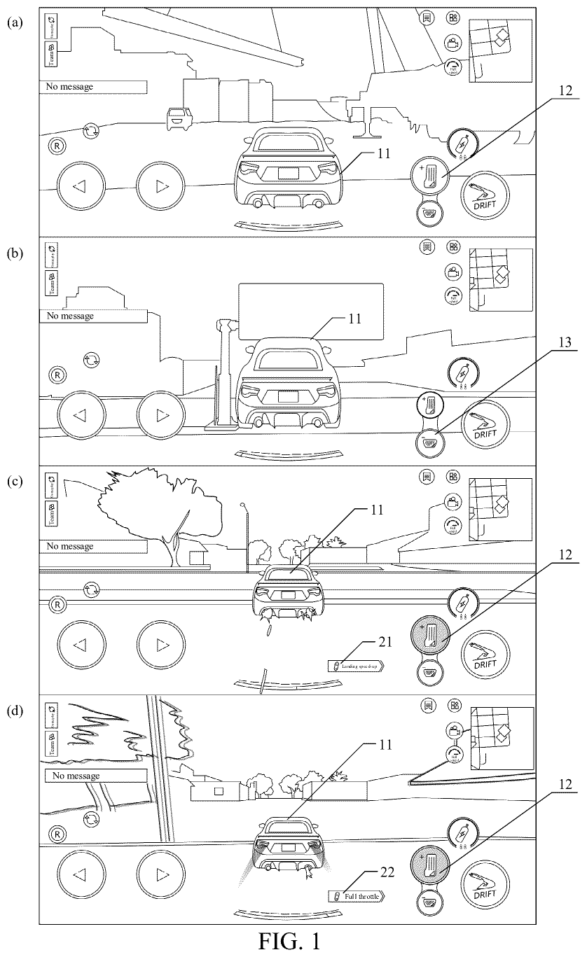

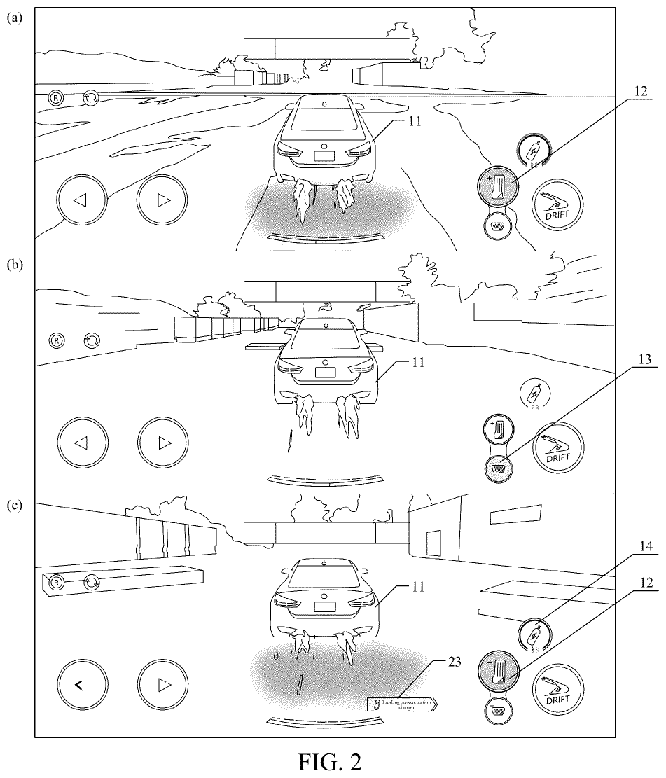

As shown in section (a) of FIG. 1 and/or section (a) of FIG. 2, in one example, before a virtual vehicle 11 is about to fly, a user may tap or press and hold a throttle control 12, to control the virtual vehicle to move forward at an accelerating rate while the vehicle is on the ground.

As shown in section (b) of FIG. 1 and/or section (b) of FIG. 2, in one example, after the virtual vehicle 11 begins to fly (i.e., leave the ground), if a throttle is in a held state, the user may tap a first brake control 13 to cause the virtual vehicle 11 to change from the throttle held state to a throttle released state.

As shown in section (c) of FIG. 1, in one example, in 1.5 seconds from landing of the virtual vehicle 11, if the user taps the throttle control 12 to trigger a landing speed-up trick, a power of the virtual vehicle 11 may be raised to 1.5 times a standard power, and the virtual vehicle 11 may move, with 1.5 times the standard power, forward at an accelerating rate for at least 0.3 seconds. Alternatively, as shown in section (c) of FIG. 2, in another example, in 1.5 seconds from landing of the virtual vehicle 11, if the user taps a nitrogen control 14 and then taps the throttle control 12, a nitrogen pressurization trick may be triggered, a power of the virtual vehicle 11 may be raised to 1.5 times a standard power, and the virtual vehicle 11 may move, with 1.5 times the standard power, forward at an accelerating rate for at least 0.3 seconds.

As shown in section (d) of FIG. 1, in some examples, after performing an operation of tapping the throttle control 12, if the user does not release a finger and presses and holds the throttle control 12, after 0.3 seconds, the virtual vehicle 11 may continue to move forward at an accelerating rate with 1.5 times the standard power. A duration of the virtual vehicle 11 continuing to move forward at the accelerating rate with 1.5 times the standard power may be at most 0.5 seconds.

In other words, after the virtual vehicle lands, a fast speed-up of the virtual vehicle can be implemented by triggering the landing speed-up trick or the nitrogen pressurization trick within a certain amount of time after the virtual vehicle lands.

In some arrangements, aspects described herein may be performed by a client of a target application program. For example, the client may be a client of an auto racing game-type application program. As shown in FIG. 3, a virtual vehicle 11, a race track (for example, a road), and operation controls configured for controlling the virtual vehicle 11 are displayed in an interface of an example racing game-type application program client. The operation controls include a throttle control 12, a first brake control 13, a nitrogen control 14, a second brake control 15, a direction adjustment control 16, and a reset control 17.

The throttle control 12 may be configured for controlling the virtual vehicle 11 to accelerate (e.g., move at an accelerating rate). A user may control the virtual vehicle 11 to move at the accelerating rate through an operation for the throttle control 12. In some examples, when the throttle control 12 is continuously triggered (for example, the throttle control is pressed and held), the virtual vehicle 11 can remain in a throttle held state and accelerate continuously. If a trigger body (e.g., a user's finger or other body part) leaves the throttle control 12, the virtual vehicle 11 changes from the throttle held state to a throttle released state, and the virtual vehicle 11 no longer accelerates (for example, may instead maintain a constant velocity or may continuously decelerates).

In other arrangements, to avoid a case in which the user is required to trigger the throttle control for an extended period of time, after the throttle control 12 is triggered (for example, the throttle control is tapped), the virtual vehicle 11 can still remain in the throttle held state even if the trigger body leaves the throttle control 12. In the throttle held state, when the first brake control 13 is triggered, the virtual vehicle 11 may change from the throttle held state to the throttle released state and no longer accelerates.

The first brake control 13 may be configured for controlling the virtual vehicle 11 to decelerate or reverse. During an acceleration movement of the virtual vehicle 11, the user may control the virtual vehicle 11 to move at a slowly decelerating rate through a tap operation for the first brake control 13. Alternatively, the user may control the virtual vehicle 11 to move at a fast decelerating rate through a continuous pressing operation for the first brake control 13, and continue to control the virtual vehicle 11 to reverse if the continuous pressing operation does not disappear when a speed of the virtual vehicle 11 is reduced to zero. In some arrangements, the throttle control 12 and the first brake control 13 might not be allowed to be pressed simultaneously, and if one of the throttle control 12 and the first brake control 13 is in a triggered state, triggering of the other control is disallowed or prevented.

The nitrogen control 14 may be configured for controlling the virtual vehicle 11 to accelerate based on accumulated nitrogen resources. The user controls, through an operation for the nitrogen control 14, the virtual vehicle 11 to accelerate by consuming the accumulated nitrogen resources. In some arrangements, a nitrogen indication icon may also be displayed in a user interface. The nitrogen indication icon may include a plurality of sub-icons, and the sub-icons may correspond to a first display style and a second display style. A quantity of nitrogen resources accumulated by the virtual vehicle 11 may be positively correlated with a quantity of sub-icons displayed in the first display style. In a process of accumulating the nitrogen resources, a transformation process of the sub-icon in the nitrogen indication icon from the second display style to the first display style may be displayed to represent that the nitrogen resources are or is being accumulated. In a process of consuming the nitrogen resources, a transformation process of the sub-icon in the nitrogen indication icon from the first display style to the second display style may be displayed to represent that the nitrogen resources are or is being consumed.

The second brake control 15 may be configured for controlling the virtual vehicle 11 to move at a decelerating rate. The second brake control 15 may be a control different from the first brake control 13. For example, the first brake control 13 may be a foot brake control, and the second brake control 15 may be a hand brake control. The user may control the virtual vehicle 11 to enter a drifting state through an operation for the direction adjustment control 16 and a first-tap operation for the second brake control 15, and then control, through a second-tap operation for the second brake control 15, the virtual vehicle 11 to move at a rapidly decelerating rate until the speed is zero. In the drifting state, when the second brake control 15 is tapped again, rotation or turning of a vehicle front towards a drifting direction is accelerated, and the virtual vehicle 11 decelerates dramatically.

A slow deceleration movement, a fast deceleration movement, and a rapid deceleration movement may be three different deceleration manners of the virtual vehicle. For example, deceleration efficiency of the slow deceleration movement may be less than deceleration efficiency of the fast deceleration movement, and the deceleration efficiency of the fast deceleration movement may be less than deceleration efficiency of the rapid deceleration movement.

The direction adjustment control 16 may be configured for controlling a vehicle front orientation of the virtual vehicle 11. The user may control, through an operation for the direction adjustment control 16, the vehicle front orientation of the virtual vehicle 11 to perform adjustment. In some examples, the direction adjustment control 16 may include a plurality of sub-controls, and different sub-controls may correspond to different adjustment directions. In other examples, the direction adjustment control 16 may include a slider. The user may adjust the vehicle front orientation of the virtual vehicle 11 through a sliding operation for the slider, and different sliding directions may correspond to different adjustment directions.

The reset control 17 may be configured for controlling the virtual vehicle 11 to exit a stuck state. During a movement of the virtual vehicle 11, if the virtual vehicle 11 is not controllable due to the virtual vehicle 11 moving to a special spot, the virtual vehicle 11 may be controlled to exit the special spot and reset to a nearest non-special spot through an operation for the reset control 17, so that the virtual vehicle 11 continues to move from the non-special spot.

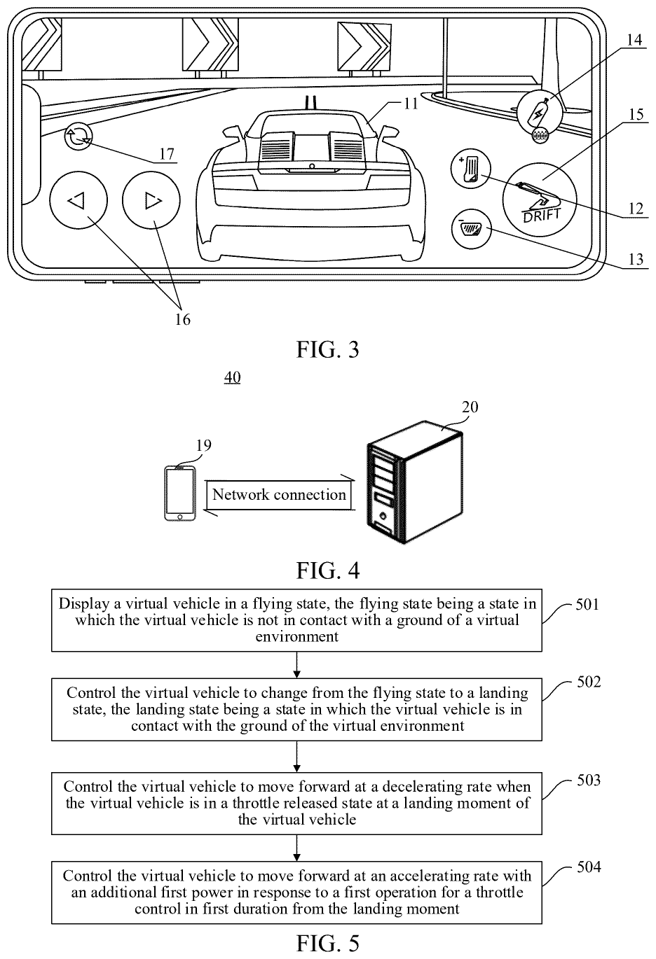

FIG. 4 is a schematic diagram of an example implementation environment according to one or more aspects described herein. The implementation environment may include a virtual vehicle control system. As shown in FIG. 4, a system 40 may include a terminal device 19.

A target application program, for example, a client of the target application program, may be installed and run in the terminal device 19. In some examples, a user account may be logged in through the client. The terminal device may be an electronic device having data computing, processing, and storage functions. The terminal device may be a smartphone, a tablet computer, a personal computer (PC), a wearable device, or the like, but is not limited to these examples. The target application program may be a game application program such as a car racing-type game application program, a racing-type game application program, a shooting-type game application program, a multiplayer gunfight-type survival game application program, a battle royale survival-type game application program, a location based service (LBS)-type game application program, or a multiplayer online battle arena (MOBA)-type game application program, but is not limited to these examples. The target application program may alternatively be any application program having a control function of a virtual vehicle, such as a social application program, a payment application program, a video application program, a music application program, a shopping application program, or a news application program. According to methods and processes described herein, blocks may be performed by the terminal device 19, such as a client running in the terminal device 19.

According to some aspects, the system 40 may further include a server 20. There may be a communication connection (for example, a network connection) established between the server 20 and the terminal device 19, and the server 20 may be configured for providing background services for the target application program. The server may be an independent physical server, or may be a server cluster or a distributed system including a plurality of physical servers, or may be a cloud server that provides cloud computing services.

Various examples arrangements and aspects are described below.

FIG. 5 is a flowchart of an example virtual vehicle control method according to one or more aspects described herein. In this example, the client described above is used for description. The method may include the following processes (501 to 504).

Block 501: Display a virtual vehicle in a flying state, the flying state being a state in which the virtual vehicle is not in contact with a ground of a virtual environment.

In some example, the virtual vehicle in an interface may be in the flying state when a vehicle speed is high and a road is uneven (for example, the road is broken or excessively tough). In one example, the flying state is a state in which all tires of the virtual vehicle are off the ground. For example, if the virtual vehicle is a four-wheel racing car, the virtual vehicle is in the flying state when four tires of the virtual vehicle are in an off-ground state at the same time. In another example, if the virtual vehicle is a two-wheel motorcycle, the virtual vehicle is in the flying state when two tires of the virtual vehicle are in the off-ground state at the same time.

In some arrangements, the virtual environment may be a scene displayed (or provided) by the client when the client of the target application program (for example, a game application program) runs on a terminal device, and the virtual environment is a scene, such as a virtual city, a virtual playing field, or a virtual map, created for displaying the virtual vehicle. The virtual environment may be a simulated environment of the real world, a semi-simulated semi-imaginary environment, or a purely imaginary environment. The virtual environment may be a two-dimensional virtual environment, a 2.5-dimensional virtual environment, or a three-dimensional virtual environment. Aspects described herein are not limited to these examples.

The virtual vehicle may be an object that a user controls in the target application program. The virtual vehicle may be presented in a three-dimensional form or in a two-dimensional form, but is not limited to such examples. In some arrangements, when the virtual environment in which the virtual vehicle is located is the three-dimensional virtual environment, the virtual vehicle may be a three-dimensional model created based on a three-dimensional technology. The virtual vehicle may have its own shape and volume in the three-dimensional virtual environment and occupy a part of space in the three-dimensional virtual environment.

In the flying state, if the virtual vehicle is in a throttle held state, engine idling may cause a high rotation speed, and the tires may have difficulty in gripping the ground for a short time after landing. Consequently, the virtual vehicle may enter a slipping state. The engine speed may be reduced by releasing a throttle before the virtual vehicle lands, so that the virtual vehicle is prevented from entering the slipping state after landing, and the virtual vehicle can accelerate straight after the virtual vehicle is refueled subsequently.

Block 502: Control the virtual vehicle to change from the flying state to a landing state, the landing state being a state in which the virtual vehicle is in contact with the ground of the virtual environment.

In some arrangements, regardless of how many tires the virtual vehicle has, the virtual vehicle is in the landing state provided that at least one tire touches the ground during a fall of the virtual vehicle in the flying state.

Block 503: Control the virtual vehicle to move forward at a decelerating rate when the virtual vehicle is in a throttle released state at a landing moment of the virtual vehicle.

The landing moment may refer to a moment at which the flying state is changed to the landing state. When the virtual vehicle lands, because the virtual vehicle may be in the throttle released state, the virtual vehicle may have no power, and the virtual vehicle may move forward by inertia. In addition, due to presence of resistance such as “friction”, the virtual vehicle may continuously decelerate until the vehicle speed is zero in the throttle released state.

In some arrangements, when the virtual vehicle is in the flying state, the virtual vehicle may be controlled to change from the throttle held state to the throttle released state in response to an operation for a first brake control.

In other arrangements, when a throttle control needs to be continuously triggered to keep the virtual vehicle in the throttle held state and the virtual vehicle is in the flying state, the virtual vehicle may be changed from the throttle held state to the throttle released state in response to a stop of an operation of the throttle control.

Block 504: Control the virtual vehicle to move forward at an accelerating rate with an additional first power in response to a first operation for the throttle control in first duration from the landing moment.

In some arrangements, such as that shown in FIG. 1, second prompt information 21 may be displayed in response to a first operation for the throttle control 12 in the first duration from the landing moment. The second prompt information 21 may be configured for indicating that a landing speed-up trick is triggered, and the landing speed-up trick may be a trick in which the virtual vehicle moves forward at the accelerating rate with the additional first power.

In some arrangements, if the user performs the first operation for the throttle control in the first duration counted from the landing moment of the virtual vehicle, the virtual vehicle may move forward at an accelerating rate with the superimposed additional first power based on a standard power. If the first operation for the throttle control is not detected in the first duration and is detected after the first duration ends, the virtual vehicle might only move forward with the standard power, and there is no addition of the additional first power.

Standard power may refer to a power corresponding to a current throttle gear of the virtual vehicle. In some example, the throttle of the virtual vehicle may correspond to one or more gears. When the throttle of the virtual vehicle corresponds to a plurality of gears, powers corresponding to different gears may be different, and the user can switch the power of the virtual vehicle by switching the gear of the virtual vehicle. Similarly, the greater the power of the virtual vehicle, the greater the acceleration of the virtual vehicle may be (the faster the virtual vehicle accelerates).

In some arrangements, the additional first power may be superimposed based on the standard power, to obtain an actual power of the virtual vehicle; and the virtual vehicle may be controlled to move forward at an accelerating rate with the actual power in second duration. In other words, after detecting the first operation for the throttle control, the client may give the virtual vehicle a power, namely, the standard power, corresponding to a current gear. On this basis, the additional first power may be superimposed to obtain the actual power of the virtual vehicle, and the virtual vehicle may be driven with the actual power. The additional first power has an effective duration, namely, the second duration. After the effective or second duration ends, the additional first power ends or is weakened.

In some arrangements, the additional first power may be a fixed value, and the value may be set based on actual circumstances (e.g., real-world data) or as needed or desired, and is not limited to any particular examples described herein.

In some arrangements, the additional first power may be obtained through calculation based on the standard power. For example, the additional first power may be obtained by the standard power multiplied by a coefficient (in other words, the actual power is the standard power multiplied by a number greater than 1). The coefficient may be 0.3, 0.5, 0.8, 1, or the like. In some examples, the multiple may be based on actual circumstances (e.g., real-world data) or as needed or desired, and is not limited to any particular examples described herein.

The first operation may be an operation such as tap or press and hold. The first duration may be 1 second, 1.5 seconds, 2 seconds, or the like, and the second duration may be 0.2 seconds, 0.3 seconds, 0.5 seconds, or the like. Specific durations of the first duration and the second duration may be set based on actual circumstances (e.g., real-world data) or as needed or desired, and is not limited to any particular examples described herein.

In a possible arrangement, the terminal device may determine a time interval between the landing moment and a moment of receiving the first operation for the throttle control, and determine the additional first power and/or the second duration based on the time interval.

In some arrangements, the additional first power may be negatively correlated with the time interval. In other words, the faster the throttle control is triggered after the virtual vehicle lands, the more additional power can be obtained. The second duration may be positively correlated with the time interval. In other words, the faster the throttle control is triggered after the virtual vehicle lands, the longer the time of acceleration with the additional first power.

By associating the additional first power and/or the second duration with a trigger timing of the throttle control, differentiated landing speed-up may be implemented. This may help improve competitiveness and authenticity in a virtual vehicle control process.

In some arrangements, the virtual vehicle may be controlled to move forward at an accelerating rate with additional 0.5 times the standard power in response to the tap or press and hold operation of the throttle control within 1.5 seconds from the landing moment. That is, the actual power of the virtual vehicle may be 1.5 times the standard power.

According to aspects described herein, in a process of the virtual vehicle flying and landing, the user may perform a landing speed-up trick for the virtual vehicle by releasing the throttle when the virtual vehicle flies and performing the first operation for the throttle control after the virtual vehicle lands, the virtual vehicle can obtain the additional power for certain duration to move forward, and richness of a control manner of the virtual vehicle can be improved.

In addition, the additional power for the certain duration brought by the landing speed-up trick of the virtual vehicle may partially or entirely cancel impact of the virtual vehicle flying and landing on a vehicle speed. This may improve the user experience of controlling the virtual vehicle.

In addition, according to various aspects, a change in operating experience between a case in which the virtual vehicle flies and a case in which the virtual vehicle runs on a road may be more properly transitioned. This may improve the operability of the virtual vehicle and the authenticity in the control process.

In some examples, the terminal device may control the virtual vehicle to enter the slipping state when the virtual vehicle is in the throttle held state at the landing moment of the virtual vehicle. In the slipping state, the virtual vehicle may be controlled to move forward with a curtailed power.

For example, if the virtual vehicle lands in the throttle held state, the virtual vehicle may lose stability and slip with the impact of the landing. In this case, the virtual vehicle may be powered due to the virtual vehicle being in the throttle held state, but the power of the virtual vehicle may be curtailed due to the slip, and the power may be less than the standard power. In some arrangements, the curtailed power of the virtual vehicle may be 0.2 times that of the standard power. In other words, a power decrement is 0.8 times the standard power. A multiple relationship/proportional relationship between the power decrement and the standard power may be set based on actual circumstances (e.g., real-world data and/or requirements) or as needed or desired, and is not limited to these examples. In some arrangements, the cutting power may be a fixed value irrespective of the standard power, and a specific value of the cutting power may be set based on actual circumstances (e.g., real-world data and/or requirements) or as needed or desired, and is not limited to these examples.

In some arrangements, the terminal device may control the virtual vehicle to exit the slipping state in response to the operation for the first brake control, and a third operation for the throttle control when the virtual vehicle is in the slipping state. After the virtual vehicle exits the slipping state, the terminal device may control the virtual vehicle to move forward with the additional first power, the operations for the first brake control and the throttle control being triggered sequentially. For example, the user may trigger the first brake control before triggering the throttle control.

In some arrangements, the brake control includes a hand brake control and a foot brake control. The first brake control may be the foot brake control.

According to one or more aspects, the virtual vehicle may slip because the virtual vehicle is still in the throttle held state when the virtual vehicle is unstable. Therefore, in the slipping state, the first brake control may first be triggered, so that the virtual vehicle loses the power, to stabilize the virtual vehicle. Then, the throttle control may be triggered to apply the power to the stabilized virtual vehicle. If the user performs the operation for the first brake control first (for example, taps the first brake control) and then performs the third operation for the throttle control (for example, taps or presses and holds the throttle control) when the virtual vehicle is in the slipping state, the landing speed-up trick may also be triggered, and the virtual vehicle may obtain an addition of the additional first power for the second duration based on the standard power.

In some arrangements, if the operation for the first brake control is detected when the virtual vehicle is in the slipping state, the virtual vehicle may exit the slipping state. In addition, for a certain duration (for example, 1 second, 1.5 seconds, or 2 seconds) from the operation for the first brake control, if the third operation for the throttle control is detected, the landing speed-up trick may be triggered, and the virtual vehicle may move forward with the additional first power. In some examples, the third operation for the throttle control and the first operation for the throttle control may be the same operation.

In the foregoing example, when the throttle of the virtual vehicle is not released and the slipping state occurs after the virtual vehicle lands, the landing speed-up trick may still be triggered by performing the operation for the first brake control first and then performing the first operation for the throttle control, so that diversity and inclusiveness of the control manner of the landing speed-up trick is improved and a success rate of the landing speed-up trick is improved.

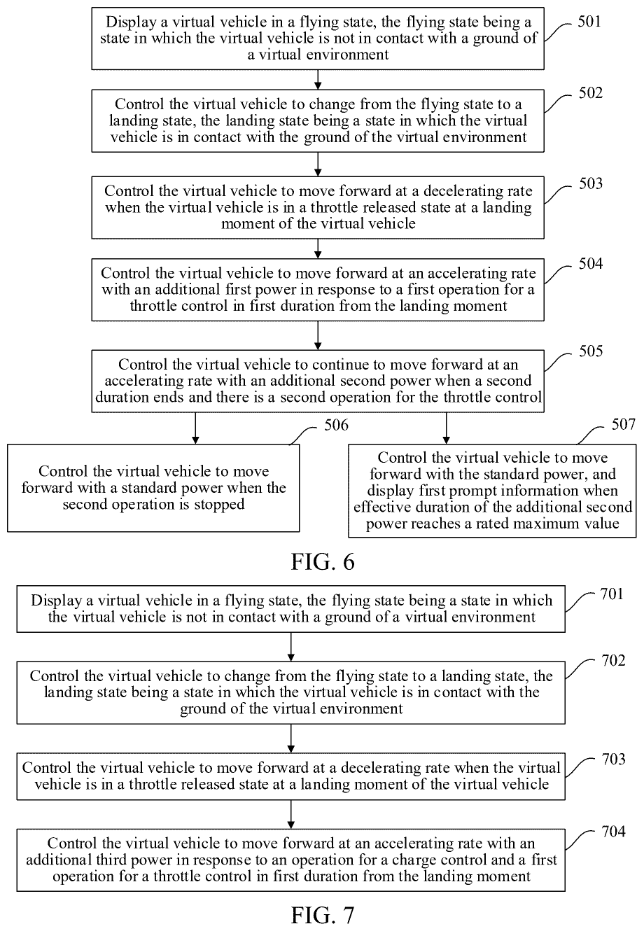

Referring to FIG. 6, after block 504, the virtual vehicle control method may further include the following processes (505 to 507).

Block 505: Control the virtual vehicle to continue to move forward at an accelerating rate with an additional second power when the second duration ends and there is a second operation for the throttle control.

In some arrangements, the end of the second duration may indicate that the additional first power is no longer effective. At this point, if the second operation for the throttle control is detected, it may indicate that the user still expects to gain an additional power, so that the virtual vehicle may be controlled to continue to move forward at the accelerating rate with the superimposed additional second power based on the standard power.

The additional second power may be determined in similar fashion to the determination of the additional first power, and details are not described here again. In some examples, the additional second power may be less than the additional first power; or the additional second power is greater than the additional first power; or the additional second power may be equal to the additional first power.

In some arrangements, the second operation for the throttle control may be a continuation of the first operation for the throttle control. For example, the first operation for the throttle control may be touching or pressing the throttle control. After the second duration ends, if it is detected that the touching or pressing operation for the throttle control has not stopped or disappeared, and that a touch body keeps touching or pressing the throttle control, it may be determined that the second operation for the throttle control is detected.

In some arrangements, when the throttle control supports maintaining the throttle held state after the throttle control is triggered, the second duration ends, and there is no operation for the first brake control, the terminal device may control the vehicle to continue to move forward at the accelerating rate with the additional second power.

In some examples, there may also be a limitation for duration in which the virtual vehicle moves forward at the accelerating rate with the additional second power. For example, the duration in which the virtual vehicle moves forward at the accelerating rate with the additional second power may be less than or equal to a rated maximum value, such as 0.3 seconds, 0.5 seconds, or 0.8 seconds. A specific value may be set in a variety of ways including based on actual circumstances (e.g., real-world data) as needed or desired, but is not limited to any particular example.

Block 506: Control the virtual vehicle to move forward with the standard power when the second operation is stopped.

In some arrangements, while the virtual vehicle continues to move forward at the accelerating rate with the additional second power, the additional second power may stop being effective/may be cancelled in a case where stoppage of the second operation is detected, even if the effective duration of the additional second power has not reached the rated maximum value. In this way, the virtual vehicle can only move forward with the standard power.

In some arrangements, when the throttle control supports maintaining the throttle held state after the throttle control is triggered, if there is the operation of the first brake control, the terminal device may control the vehicle to move forward with a power less than the standard power.

Block 507: Control the virtual vehicle to move forward with the standard power, and display first prompt information when the effective duration of the additional second power reaches the rated maximum value.

In some arrangements, such as those shown in FIG. 1 or FIG. 2, the first prompt information 22 may be configured for indicating that a full-throttle trick is triggered, the full-throttle trick being a trick in which the effective duration of the additional second power reaches the rated maximum value.

After the effective duration of the additional second power reaches the rated maximum value, the additional second power may be stopped/cancelled even if the second operation is not stopped yet. In this way, the virtual vehicle can only move forward with the standard power.

In some arrangements, only one of the foregoing blocks 506 and 507 might be performed, or neither of the foregoing blocks 506 and 507 may be performed.

According to the above aspects, after an acceleration effect of the landing speed-up trick is implemented, the virtual vehicle can move at the accelerating rate by pressing and holding the throttle control to obtain the additional second power, and the user can freely control the specific effective duration of the additional second power within a duration of the rated maximum value (e.g., a maximum allowable duration). Such aspects may further improve the richness of the control manner of the virtual vehicle.

FIG. 7 is a flowchart of an example virtual vehicle control method according to one or more aspects. The client described above is used for description of this method. The method may include the following processes (701 to 704).

Block 701: Display a virtual vehicle in a flying state, the flying state being a state in which the virtual vehicle is not in contact with a ground of a virtual environment.

In some arrangements, when the virtual vehicle is in the flying state, the virtual vehicle is controlled to change from a throttle held state to a throttle released state in response to an operation for a first brake control.

Block 702: Control the virtual vehicle to change from the flying state to a landing state, the landing state being a state in which the virtual vehicle is in contact with the ground of the virtual environment.

Block 703: Control the virtual vehicle to move forward at a decelerating rate when the virtual vehicle is in the throttle released state at a landing moment of the virtual vehicle.

The landing moment may be a moment at which the flying state is changed to the landing state.

The details of block 701 to block 703 are substantially similar to those of block 501 to block 503, and details are not described here again.

Block 704: Control the virtual vehicle to move forward at an accelerating rate with an additional third power in response to an operation of a charge control and a first operation of a throttle control within a first duration from the landing moment.

In some arrangements, as shown in FIG. 2, if the operation of the charge control (for example, a nitrogen control 14) is detected first and then the first operation of the throttle control 12 is detected within the first duration from the landing moment, third prompt information 23 may be displayed. For example, the third prompt information 23 may be configured for indicating that a nitrogen pressurization trick is triggered, and the nitrogen pressurization trick being a trick in which the virtual vehicle moves forward at the accelerating rate with the additional third power.

In some arrangements, if a user triggers the charge control (for example, the charge control is tapped) and then triggers the throttle control within the first duration counted from the landing moment of the virtual vehicle, the virtual vehicle moves forward at an accelerating rate with the superimposed additional third power based on a standard power. If the operation of the charge control is not detected first and then the first operation for the throttle control is detected within the first duration, but the operation of the throttle control is detected after the first duration ends, the virtual vehicle might only move forward with the standard power and without addition of the additional third power.

In some arrangements, the additional third power may be superimposed based on the standard power, to obtain an actual power of the virtual vehicle; and the virtual vehicle may be controlled to move forward at an accelerating rate with the actual power in third duration. In other words, after detecting the operation for the charge control before detecting the first operation for the throttle control, the client may give the virtual vehicle a power, namely, the standard power, corresponding to a current gear. On this basis, the additional third power may be superimposed to obtain the actual power of the virtual vehicle, and the virtual vehicle may be driven with the actual power. The additional third power has an effective duration, namely, the third duration. After the third duration ends, the additional third power may also end.

Determining the additional third power may be performed in similar fashion to determining the additional first power, and thus, details are not described here again. In some arrangements, because additional charge is used for acceleration, the additional third power may be greater than the additional first power.

The third duration may be 0.5 seconds, 1.5 seconds, 2 seconds, or the like. A specific value of the third duration may be set based on actual circumstances or as needed, and is not limited to any specific example.

In an example, a terminal device can determine a first time interval between the landing moment and a moment of receiving the operation for the charge control, and a second time interval between the moment of receiving the operation for the charge control and a moment of receiving the first operation for the throttle control, and determine the additional third power and/or the third duration based on the first and second time intervals.

In some examples, the additional third power may be negatively correlated with the first time interval and the second time interval. In other words, the faster the charge control and throttle control are triggered after the virtual vehicle lands, the greater the additional power that can be obtained. The third duration may be positively correlated with the time interval. In other words, the faster the charge control and throttle control are triggered after the virtual vehicle lands, the longer the time of acceleration with the additional third power may be.

By associating the additional third power and/or the third duration with a triggering timing of the charge control and throttle control, a differentiated landing speed-up may be implemented. This helps improve competitiveness and authenticity in a control process.

In some arrangements, the operation for the charge control may be completed before the virtual vehicle lands. Before the virtual vehicle lands, and after a throttle is released, an engine can be filled with nitrogen gas to a certain density, and (the engine of) the virtual vehicle can be powered up for short time by igniting the nitrogen gas through the throttle.

In some examples, if the operation for the charge control is detected before the first operation for the throttle control is detected within 1.5 seconds from the landing moment, the virtual vehicle may be controlled to move forward at accelerating rate with additional 1 times the standard power. For example, the actual power of the virtual vehicle may be 2 times the standard power.

In some arrangements, a fixed acceleration of x1 km/h/s is superimposed based on a current speed after the nitrogen pressurization trick is triggered, while the virtual vehicle obtains an additional limit speed of x2 km/h (where the limit speed may not be reached). The fixed acceleration provided by the nitrogen pressurization trick may begin to decay linearly after the virtual vehicle accelerates to a speed of y km/h from the virtual vehicle limit speed, with the acceleration decaying to zero when the virtual vehicle reaches the limit speed.

For example, assuming that a speed at which the virtual vehicle lands without slipping is 50 km/h, the limit speed may be 400 km/h, x1=15, x2=15, and y=200. After the nitrogen pressurization trick is triggered, the virtual vehicle may obtain fixed acceleration of 15 km/h/s while the limit speed of the virtual vehicle is increased to 400+15=415 km/h. The fixed acceleration (15 km/h/s) provided by the nitrogen pressurization trick will begin to decay linearly after a virtual vehicle speed reaches 415−200=215 km/h, and the acceleration decreases to zero when the virtual vehicle speed reaches 415 km/h. In some cases, a maximum speed addition might not be reached due to a short effective duration of the trick. That is, it might not be possible to reach the limit speed.

Aspects of block 704 are substantially similar to block 504, and those details are not described here again.

According to the foregoing aspects, in a process of the virtual vehicle flying and landing, the user may implement the nitrogen pressurization trick for the virtual vehicle by releasing the throttle when the virtual vehicle flies, and by performing the operation for the charge control first and then performing the first operation for the throttle control, the virtual vehicle can obtain the additional power for certain duration to move forward, and richness of a control manner of the virtual vehicle may be improved.

In some arrangements, the terminal device may control the virtual vehicle to enter a slipping state when the virtual vehicle is in the throttle held state at the landing moment of the virtual vehicle. In the slipping state, the terminal device may control the virtual vehicle to move forward with a curtailed power.

In some arrangements, the terminal device controls the virtual vehicle to exit the slipping state when the virtual vehicle is in the slipping state and the operation for the first brake control, the operation for the charge control, and a third operation for the throttle control are sequentially received. After exiting the slipping state, the virtual vehicle is controlled to move forward with the additional third power.

According to one or more aspects, in the slipping state, the first brake control may be triggered, so that the virtual vehicle loses power, to stabilize the virtual vehicle. Then, the charge control and the throttle control may be triggered sequentially to charge the stabilized virtual vehicle with nitrogen and apply power. If the user triggers the first brake control, the charge control, and the throttle control sequentially when the virtual vehicle is in the slipping state, the nitrogen pressurization trick may also be triggered, and the virtual vehicle may obtain an addition of the additional third power for the third duration based on the standard power.

In some arrangements, if the operation for the first brake control is detected when the virtual vehicle is in the slipping state, the virtual vehicle may exit the slipping state. In addition, within a certain duration (for example, 1 second, 1.5 seconds, or 2 seconds) from the operation for the first brake control, if the operation for the charge control is detected before the first operation for the throttle control is detected, the nitrogen pressurization trick may be triggered and the virtual vehicle may move forward with the additional third power. Beyond the certain duration, a slip may end, and the nitrogen pressurization trick might not be triggerable again. In some examples, the third operation for the throttle control and the first operation for the throttle control may be the same operation.

In the foregoing examples, when the throttle of the virtual vehicle is not released and the slipping state occurs after the virtual vehicle lands, the nitrogen pressurization trick may still be triggered by performing the operation for the first brake control first and then performing the first operation for the throttle control, so that diversity and inclusiveness of an operation manner of the nitrogen pressurization trick may be improved and a success rate of the nitrogen pressurization trick may be improved.

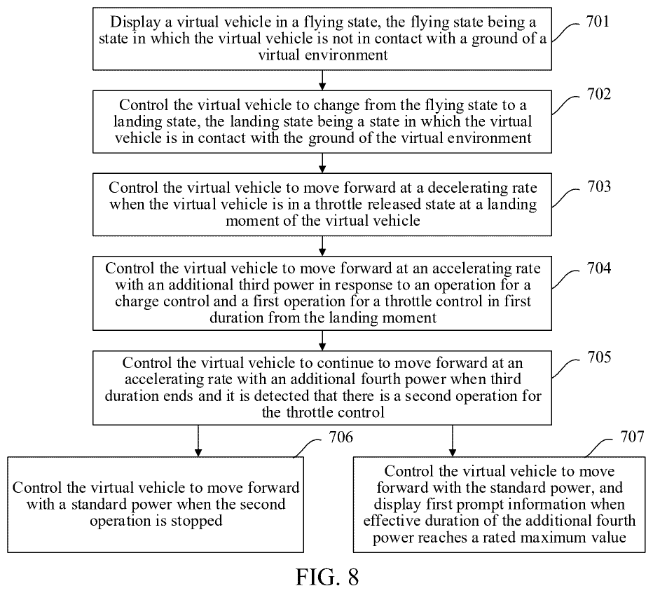

Referring to FIG. 8, after block 704, the virtual vehicle control method may further include the following processes (705 to 707).

Block 705: Control the virtual vehicle to continue to move forward at an accelerating rate with an additional fourth power when the third duration ends and there is a second operation for the throttle control.

In some arrangements, the end of the second duration may indicate that the additional third power is no longer effective. At this point, if the second operation for the throttle control is detected, it may indicate that the user still expects to gain an additional power, so that the virtual vehicle may be controlled to continue to move forward at the accelerating rate with the superimposed additional fourth power based on the standard power.

In some arrangements, the additional fourth power may be less than the additional third power.

Block 706: Control the virtual vehicle to move forward with the standard power when the second operation is stopped.

In some arrangements, while the virtual vehicle continues to move forward at the accelerating rate with the additional third power, the additional third power stops being effective/is cancelled in a case where stoppage of the second operation is detected, even if the effective duration of the additional third power has not reached the rated maximum value. In this way, the virtual vehicle can only move forward with the standard power after stoppage of the second operation.

Block 707: Control the virtual vehicle to move forward with the standard power, and display first prompt information when the effective duration of the additional fourth power reaches the rated maximum value.

In some arrangements, the first prompt information is configured for indicating that a full-throttle trick is triggered, the full-throttle trick being a trick in which the effective duration of the additional fourth power reaches the rated maximum value.

After the effective duration of the additional third power reaches the rated maximum value, the additional third power may be stopped/cancelled even if the second operation is not stopped (or has not disappeared) yet. In this way, the virtual vehicle can only move forward with the standard power.

In some arrangements, only one of the foregoing blocks 706 and 707 may be performed, or neither of the foregoing blocks 706 and 707 may be performed.

For some aspects of the aforementioned examples, details are provided with respect to FIG. 5 and FIG. 6, and those details are not described here again.

According to the foregoing description, after an acceleration effect of the nitrogen pressurization trick is implemented, the virtual vehicle can move at the accelerating rate with the additional fourth power by pressing and holding the throttle control, and the user can freely control the specific effective duration of the additional fourth power within a duration of the rated maximum value (e.g., a maximum allowable duration). This may further improve the richness of the control manner of the virtual vehicle.

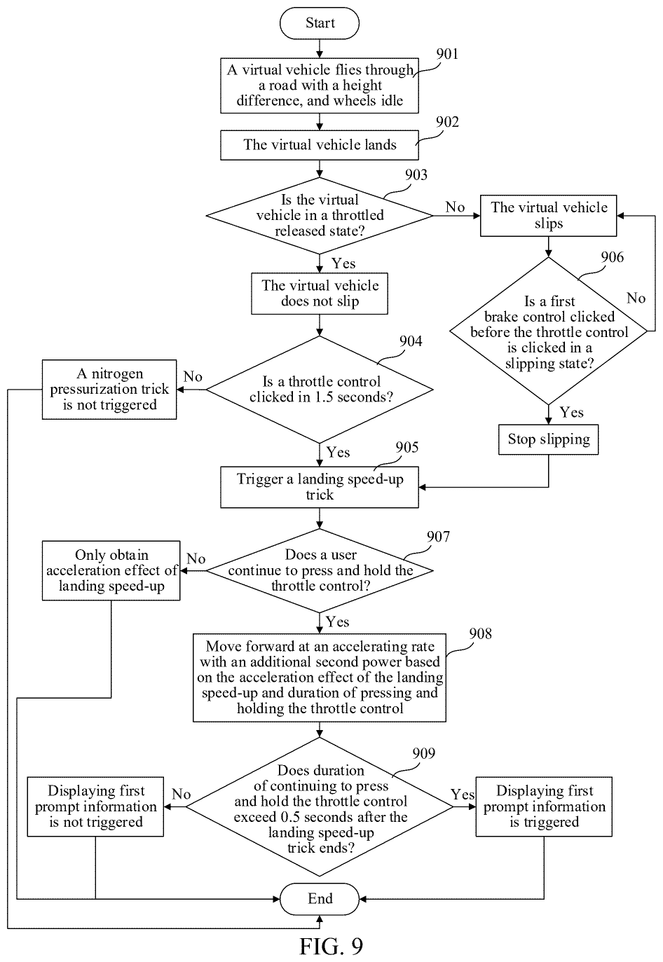

As shown in FIG. 9, a virtual vehicle control method may include the following processes (901 to 909).

Block 901: A virtual vehicle flies through a road with a height difference, and wheels idle.

Block 902: The virtual vehicle lands.

Block 903: Detect whether the virtual vehicle is in a throttled release state, and if yes, the virtual vehicle does not slip, and the following block 904 is performed; or if no, the virtual vehicle slips, and the following block 906 is performed.

Block 904: Whether an operation of tapping a throttle control is detected in 1.5 seconds, and if yes, block 905 is performed; or if no, a landing speed-up trick is not triggered.

Block 905: Trigger the landing speed-up trick.

Block 906: Detect whether a first brake control is tapped before the throttle control is tapped in a slipping state, and if yes, block 905 is performed; or if no, block 906 is further performed.

Block 907: Detect whether to continue to press and hold the throttle control after acceleration effect of the landing speed-up trick ends, and if yes, block 908 is performed; or if no, only the acceleration effect of landing speed-up is obtained.

Block 908: Move forward at an accelerating rate with an additional second power based on the acceleration effect of the landing speed-up and duration of pressing and holding the throttle control.

Block 909: Detect whether duration of continuing to press and hold the throttle control exceeds 0.5 seconds after the landing speed-up trick ends, and if yes, displaying first prompt information is triggered; or if no, displaying first prompt information is not triggered.

The above noted processes are substantially similar to previously described processes, and details are not described here again.

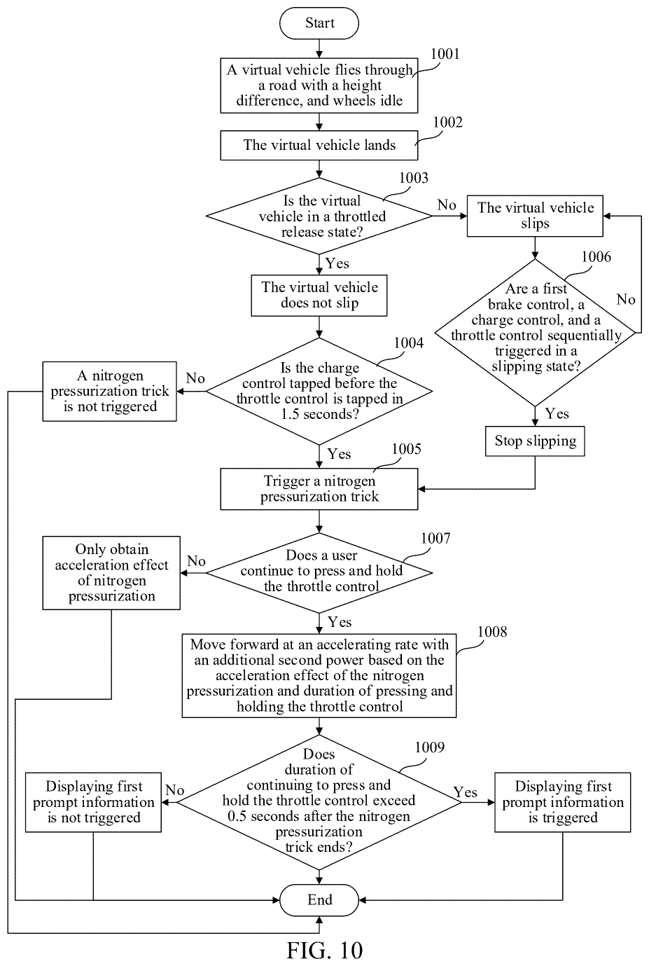

As shown in FIG. 10, a virtual vehicle control method may include the following processes (1001 to 1009).

Block 1001: A virtual vehicle flies through a road with a height difference, and wheels idle.

Block 1002: The virtual vehicle lands.

Block 1003: Detect whether the virtual vehicle is in a throttled release state, and if yes, the virtual vehicle does not slip, and the following block 1004 is performed; or if no, the virtual vehicle slips, and the following block 1006 is performed.

Block 1004: Whether a charge control is tapped first and then a throttle control is tapped in 1.5 seconds, if yes, block 1005 is performed; or if no, a nitrogen pressurization trick is not triggered.

Block 1005: Trigger the nitrogen pressurization trick.

Block 1006: Detect whether a first brake control, the charge control, and the throttle control are sequentially triggered in a slipping state, and if yes, block 1005 is performed; or if no, block 1006 is further performed.

Block 1007: Detect whether to continue to press and hold the throttle control after acceleration effect of the nitrogen pressurization trick ends, and if yes, block 1008 is performed; or if no, only the acceleration effect of nitrogen pressurization is obtained.

Block 1008: Move forward at an accelerating rate with an additional fourth power based on the acceleration effect of the nitrogen pressurization and duration of pressing and holding the throttle control.

Block 1009: Detect whether duration of continuing to press and hold the throttle control exceeds 0.5 seconds after the nitrogen pressurization trick ends, and if yes, displaying first prompt information is triggered; or if no, displaying first prompt information is not triggered.

The above noted processes are substantially similar to previously described processes, and details are not described here again.

The following describes example apparatuses that may be used for executing the methods and processes described herein.

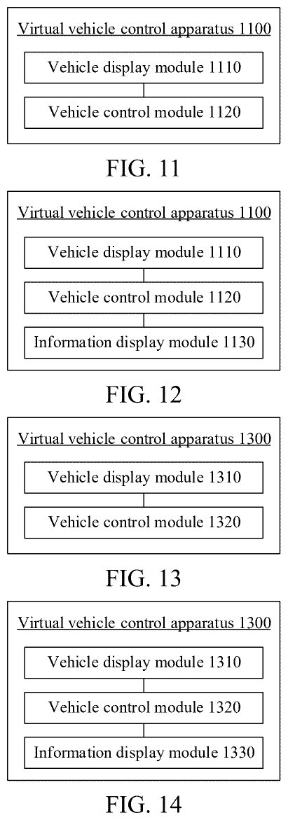

FIG. 11 is a block diagram of an example virtual vehicle control apparatus. The apparatus may have a function of implementing the example of the virtual vehicle control methods and processes, and the function may be implemented by hardware or may be implemented by hardware executing corresponding software. The apparatus may be the terminal device discussed above, or may be provided on a terminal device. The apparatus 1100 may include a vehicle display module 1110 and a vehicle control module 1120.

The vehicle display module 1110 may be configured to display a virtual vehicle in a flying state, the flying state being a state in which the virtual vehicle is not in contact with a ground of a virtual environment.

The vehicle control module 1120 may be configured to control the virtual vehicle to change from the flying state to a landing state, the landing state being a state in which the virtual vehicle is in contact with the ground of the virtual environment.

The vehicle control module 1120 may be further configured to control the virtual vehicle to move forward at a decelerating rate when the virtual vehicle is in a throttle released state at a landing moment of the virtual vehicle, the landing moment being a moment at which the flying state is changed to the landing state.

The vehicle control module 1120 may be further configured to control the virtual vehicle to move forward at an accelerating rate with an additional first power in response to a first operation for a throttle control within a first duration from the landing moment.

In some examples, the vehicle control module 1120 may be further configured to:
superimpose, based on a standard power, the additional first power to obtain an actual power of the virtual vehicle; and
control the virtual vehicle to move forward at the accelerating rate with the actual power within a second duration.

In one or more arrangements, the vehicle control module 1120 may be further configured to:
control the virtual vehicle to continue to move forward at the accelerating rate with an additional second power when the second duration ends and there is a second operation for the throttle control.

In some example, the vehicle control module 1120 may be further configured to:
control the virtual vehicle to move forward with the standard power when the second operation is stopped;
or
control the virtual vehicle to move forward with the standard power and display first prompt information when effective duration of the additional second power reaches a rated maximum value, the first prompt information being configured for indicating that a full-throttle trick is triggered, and the full-throttle trick being a trick in which the effective duration of the additional second power reaches the rated maximum value.

According to some aspects, the vehicle control module 1120 may be further configured to:
control the virtual vehicle to change from a throttle held state to the throttle released state in response to an operation for a first brake control when the virtual vehicle is in the flying state.

In one or more examples, as shown in FIG. 12, the apparatus 1100 may further include an information display module 1130.

The information display module 1130 may be configured to display second prompt information in response to the first operation for the throttle control within the first duration from the landing moment, the second prompt information being configured for indicating that a landing speed-up trick is triggered, and the landing speed-up trick being a trick in which the virtual vehicle moves forward at the accelerating rate with the additional first power.

In one or more examples, the vehicle control module 1120 may be further configured to:
control the virtual vehicle to enter a slipping state when the virtual vehicle is in a throttle held state at the landing moment of the virtual vehicle; and
control the virtual vehicle to move forward with a curtailed power in the slipping state.

In some arrangements, the vehicle control module 1120 may be further configured to:
control the virtual vehicle to exit the slipping state in response to an operation for a first brake control and a third operation for the throttle control when the virtual vehicle is in the slipping state, the operations for the first brake control and the throttle control being triggered sequentially; and
control the virtual vehicle to move forward with the additional first power after exiting the slipping state.

According to the foregoing aspects, in a process of the virtual vehicle flying and landing, a user may implement the landing speed-up trick for the virtual vehicle by releasing a throttle when the virtual vehicle flies and performing the first operation for the throttle control after the virtual vehicle lands, the virtual vehicle can obtain the additional power for certain duration to move forward, and richness of a control manner of the virtual vehicle is improved.

FIG. 13 is a block diagram of another example virtual vehicle control apparatus. The apparatus may have a function of implementing the example of the virtual vehicle control methods and processes described herein, and the function may be implemented by hardware or may be implemented by hardware executing corresponding software. The apparatus may be the terminal device introduced above, or may be provided on a terminal device. The apparatus 1300 may include a vehicle display module 1310 and a vehicle control module 1320.

The vehicle display module 1310 may be configured to display a virtual vehicle in a flying state, the flying state being a state in which the virtual vehicle is not in contact with a ground of a virtual environment.

The vehicle control module 1310 may be configured to control the virtual vehicle to change from the flying state to a landing state, the landing state being a state in which the virtual vehicle is in contact with the ground of the virtual environment.

The vehicle control module 1320 may be further configured to control the virtual vehicle to move forward at a decelerating rate when the virtual vehicle is in a throttle released state at a landing moment of the virtual vehicle, the landing moment being a moment at which the flying state is changed to the landing state.

The vehicle control module 1320 may be further configured to control the virtual vehicle to move forward at an accelerating rate with an additional third power in response to an operation for a charge control and a first operation for a throttle control within a first duration from the landing moment, the operations for the charge control and the throttle control being triggered sequentially.

In one or more examples, the vehicle control module 1320 may be further configured to:
superimpose, based on a standard power, the additional third power to obtain an actual power of the virtual vehicle; and
control the virtual vehicle to move forward at the accelerating rate with the actual power within a third duration.

In some examples, the vehicle control module 1320 may be further configured to control the virtual vehicle to continue to move forward at the accelerating rate with an additional fourth power when the third duration ends and there is a second operation for the throttle control.

In some examples, the vehicle control module 1320 may be further configured to:
control the virtual vehicle to move forward with the standard power when the second operation ends;
or
control the virtual vehicle to move forward with the standard power and display first prompt information when effective duration of the additional fourth power reaches a rated maximum value, the first prompt information being configured for indicating that a full-throttle trick is triggered, and the full-throttle trick being a trick in which the effective duration of the additional fourth power reaches the rated maximum value.

In some examples, the vehicle control module 1320 may be further configured to control the virtual vehicle to change from a throttle held state to the throttle released state in response to an operation for a first brake control when the virtual vehicle is in the flying state.

In some examples, as shown in FIG. 14, the apparatus 1300 may further include an information display module 1330.

The information display module 1330 may be configured to display third prompt information in response to the operation for the charge control and the first operation for the throttle control in the first duration from the landing moment, the third prompt information being configured for indicating that a nitrogen pressurization trick is triggered, and the nitrogen pressurization trick being a trick in which the virtual vehicle moves forward at the accelerating rate with the additional third power.

In one or more examples, the vehicle control module 1320 may be further configured to:
control the virtual vehicle to enter a slipping state when the virtual vehicle is in a throttle held state at the landing moment of the virtual vehicle; and
control the virtual vehicle to move forward with a curtailed power in the slipping state.

According to one or more aspects, the vehicle control module 1320 may be further configured to:
control the virtual vehicle to exit the slipping state when an operation for a first brake control, the operation for the charge control, and a third operation for the throttle control are sequentially received in the slipping state; and
control the virtual vehicle to move forward with the additional third power after exiting the slipping state.

According to the foregoing aspects, in a process of the virtual vehicle flying and landing, a user may implement the nitrogen pressurization trick for the virtual vehicle by releasing a throttle when the virtual vehicle flies and performing the operation for the charge control first and then performing the first operation for the throttle control, the virtual vehicle can obtain the additional power for certain duration to move forward, and richness of a control manner of the virtual vehicle is improved.

When the apparatuses provided in the foregoing descriptions implement the functions described herein, the division of functions corresponding to the foregoing function modules is only used as an example. In one or more arrangements, the functions may be allocated to and completed by different function modules according to various needs and requirements. That is, an internal structure of the device may be divided into different function modules, to complete all or some of the functions described above. In addition, the apparatuses and methods and processes described herein fall within a same conception. For details of a specific implementation process, refer to the method and process aspects described above. Details are not described here again.

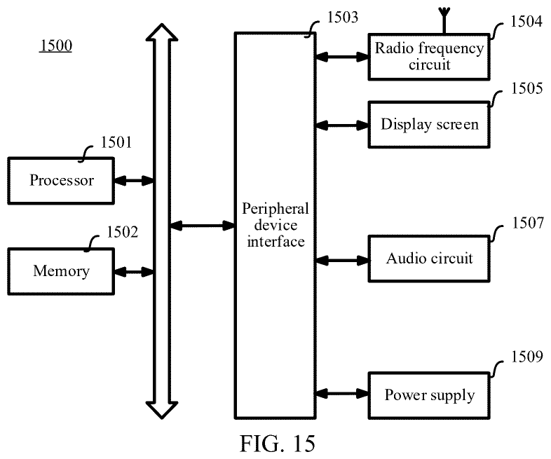

FIG. 15 is a block diagram of an example structure of a terminal device 1500 according to one or more aspects. The terminal device 1500 may be an electronic device, such as a phone, a tablet, a game host, an e-book reader, a multimedia playback device, a wearable device, or a PC. The terminal device is configured for performing the virtual vehicle control methods and processes described herein. Specifically:

The terminal device 1500 may include a processor 1501 and a memory 1502.

The processor 1501 may include one or more processing cores, for example, a 4-core processor or an 8-core processor. The processor 1501 may be implemented in at least one hardware form of a digital signal processor (DSP), field programmable gate array (FPGA), and programmable logic array (PLA). A processor 1701 may also include a main processor and a co-processor. The main processor may be a processor configured for processing data in an awake state, and may also be referred to as a central processing unit (CPU); and the co-processor may be a low power processor configured for processing data in a standby state. In some arrangements, the processor 1501 may be integrated with a graphics processing unit (GPU). The GPU may be configured for rendering and drawing content that needs to be displayed on a display screen. In some example, the processor 1501 may further include an artificial intelligence (AI) processor. The AI processor may be configured for processing a computing operation related to machine learning.

The memory 1502 may include one or more computer-readable storage media. The computer-readable storage medium may be non-transient. The memory 1502 may further include a high-speed random access memory and a non-volatile memory, for example, one or more disk storage devices or flash storage devices. In some examples, the non-transient computer-readable storage medium in the memory 1502 is configured for storing at least one instruction, at least one program, a code set, or an instruction set, and is configured to be executed by one or more processors to implement the virtual vehicle control methods and processes.

In some examples, the terminal device 1500 may further include a peripheral device interface 1503 and at least one peripheral device. The processor 1501, the memory 1502, and the peripheral device interface 1503 may be connected through a bus or a signal cable. Each peripheral device may be connected to the peripheral device interface 1503 through a bus, a signal cable, or a circuit board. Specifically, the peripheral device may include at least one of a radio frequency circuit 1504, a display screen 1505, an audio circuit 1507, and a power supply 1509.

The structure shown in FIG. 15 is not limiting on the structure of the terminal device 1500, and the terminal device 1500 may include more or fewer components than those shown in the figure, or some components may be combined, or a different component deployment may be used.

According to some aspects, a computer-readable storage medium is further provided. The storage medium has at least one instruction, at least one program, a code set, or an instruction set stored therein, and when the at least one instruction, the at least one program, the code set, or the instruction set is executed by a processor, the virtual vehicle control methods and processes are implemented.

According to some aspects, a computer program product or a computer program is further provided. The computer program product or the computer program includes computer instructions, and the computer instructions are stored in a computer-readable storage medium. A processor of a computer device reads the computer instructions from the computer-readable storage medium, and the processor executes the computer instructions, so that the computer device implements the virtual vehicle control methods and processes.

The foregoing descriptions are merely examples, and are not intended to limit the scope of various aspects described herein. Any modification, equivalent replacement, or improvement made within the spirit and principle of this disclosure shall fall within the scope of protection.

What is claimed is:

1. A virtual vehicle control method, performed by a computing device simulating vehicle movement in a virtual environment, and comprising:
displaying, by the computing device comprising a control device, a virtual vehicle in a flying state in the virtual environment, the flying state being a state in which the virtual vehicle is not in contact with a ground of the virtual environment;
controlling, by the computing device, the virtual vehicle to change from the flying state to a landing state, the landing state being a state in which the virtual vehicle is in contact with the ground of the virtual environment;
controlling, by the computing device, the virtual vehicle to move forward at a decelerating rate when the virtual vehicle is in a throttle released state at a landing moment of the virtual vehicle, the landing moment being a moment at which the flying state is changed to the landing state; and
within a first duration counted from the landing moment and in response to detecting an operation for charging prior to detecting a first operation for controlling the virtual vehicle to accelerate, controlling the virtual vehicle to move forward at an accelerating rate with an additional power.

2. The virtual vehicle control method according to claim 1, wherein the controlling the virtual vehicle to move forward at the accelerating rate with the additional power comprises:
superimposing, by the computing device, based on a standard power, the additional power to obtain an actual power of the virtual vehicle; and
controlling, by the computing device, the virtual vehicle to move forward at the accelerating rate with the actual power in a third duration.

3. The virtual vehicle control method according to claim 2, further comprising:
controlling, by the computing device, the virtual vehicle to continue to move forward at the accelerating rate with an additional fourth power when the third duration ends and there is a second operation for a throttle control.

4. The virtual vehicle control method according to claim 3, further comprising:
controlling, by the computing device, the virtual vehicle to move forward with a standard power when the second operation ends; or
controlling, by the computing device, the virtual vehicle to move forward with the standard power and displaying first prompt information when effective duration of the additional fourth power reaches a rated maximum value, the first prompt information indicating that a full-throttle trick is triggered, and the full-throttle trick being a trick in which the effective duration of the additional fourth power reaches the rated maximum value.

5. The virtual vehicle control method according to claim 1, further comprising:
controlling, by the computing device, the virtual vehicle to change from a throttle held state to the throttle released state in response to an operation for a first brake control when the virtual vehicle is in the flying state.

6. The virtual vehicle control method according to claim 4, further comprising:
displaying, by the computing device, third prompt information in response to the operation for charging and the first operation in the first duration from the landing moment, the third prompt information indicating that a nitrogen pressurization trick is triggered, and the nitrogen pressurization trick being a trick in which the virtual vehicle moves forward at the accelerating rate with the additional power.

7. The virtual vehicle control method according to claim 1, further comprising:
control the virtual vehicle to move forward at a decelerating rate when the virtual vehicle is in a throttle released state at the landing moment of the virtual vehicle; or
controlling, by the computing device, the virtual vehicle to enter a slipping state when the virtual vehicle is in a throttle held state at the landing moment of the virtual vehicle; and
controlling, by the computing device, the virtual vehicle to move forward with a curtailed power in the slipping state.

8. The virtual vehicle control method according to claim 7, further comprising:
controlling, by the computing device, the virtual vehicle to exit the slipping state in response to an operation for a first brake control and a third operation for a throttle control when the virtual vehicle is in the slipping state, the operations for the first brake control and the throttle control being triggered sequentially; and
controlling, by the computing device, the virtual vehicle to move forward with an additional first power after exiting the slipping state.

9. The virtual vehicle control method according to claim 1, further comprising:
controlling, by the computing device, the virtual vehicle to move forward at an accelerating rate with an additional first power in response to the first operation within the first duration from the landing moment, wherein the additional power is larger than the additional first power.

10. The virtual vehicle control method according to claim 9, wherein the controlling the virtual vehicle to move forward at the accelerating rate with the additional first power comprises:
superimposing, by the computing device based on a standard power, the additional first power to determine an actual power of the virtual vehicle; and
controlling, by the computing device, the virtual vehicle to move forward at the accelerating rate with the actual power for a second duration.

11. The virtual vehicle control method according to claim 10, further comprising:
controlling, by the computing device, the virtual vehicle to continue to move forward at the accelerating rate with an additional second power when the second duration ends and there is a second operation for a throttle control.

12. The virtual vehicle control method according to claim 11, further comprising:
controlling, by the computing device, the virtual vehicle to move forward with the standard power when the second operation ends; or
controlling, by the computing device, the virtual vehicle to move forward with the standard power and displaying first prompt information when effective duration of the additional second power reaches a rated maximum value, the first prompt information indicating that a full-throttle trick is triggered using the control device, and the full-throttle trick being a trick in which the effective duration of the additional second power reaches the rated maximum value.

13. The virtual vehicle control method according to claim 9, further comprising:
displaying, by the computing device, second prompt information in response to the first operation within the first duration from the landing moment, the second prompt information indicating that a landing speed-up trick is triggered, and the landing speed-up trick being a trick in which the virtual vehicle moves forward at the accelerating rate with the additional first power.

14. The virtual vehicle control method according to claim 9, further comprising:
controlling, by the computing device, the virtual vehicle to enter a slipping state when the virtual vehicle is in a throttle held state at the landing moment of the virtual vehicle; and
controlling, by the computing device, the virtual vehicle to move forward with a curtailed power in the slipping state.

15. The virtual vehicle control method according to claim 14, further comprising:
controlling, by the computing device, the virtual vehicle to exit the slipping state in response to an operation for a first brake control and a third operation for a throttle control when the virtual vehicle is in the slipping state, the operations for the first brake control and the throttle control being triggered sequentially; and
controlling, by the computing device, the virtual vehicle to move forward with the additional first power after exiting the slipping state.

16. A virtual vehicle control method, performed by a computing device simulating vehicle movement in a virtual environment, and comprising:
controlling, by the computing device comprising a control device, a virtual vehicle to accelerate along a ground of the virtual environment when the virtual vehicle is in a throttle held state;
displaying, by the computing device, the virtual vehicle in a flying state in the virtual environment, the flying state being a state in which the virtual vehicle is not in contact with the ground of the virtual environment;
while the virtual vehicle is in the flying state, in response to an operation controlling the virtual vehicle to decelerate, switching the virtual vehicle from the throttle held state to a throttle release state,
controlling, by the computing device, the virtual vehicle to change from the flying state to a landing state, the landing state being a state in which the virtual vehicle is in contact with the ground of the virtual environment;
controlling, by the computing device, the virtual vehicle to move forward at a decelerating rate when the virtual vehicle is in the throttle released state at a landing moment of the virtual vehicle, the landing moment being a moment at which the flying state is changed to the landing state; and
within a first duration counted from the landing moment and in response to an operation controlling the virtual vehicle to accelerate, controlling the virtual vehicle to move forward at an accelerating rate with an additional first power.

17. The virtual vehicle control method according to claim 16, wherein the controlling the virtual vehicle to move forward at the accelerating rate with the additional first power comprises:
superimposing, by the computing device based on a standard power, the additional first power to determine an actual power of the virtual vehicle; and
controlling, by the computing device, the virtual vehicle to move forward at the accelerating rate with the actual power for a second duration.

18. The virtual vehicle control method according to claim 16, further comprising:
displaying, by the computing device, prompt information in response to the operation controlling the virtual vehicle to accelerate within the first duration from the landing moment, the prompt information indicating that a landing speed-up trick is triggered, and the landing speed-up trick being a trick in which the virtual vehicle moves forward at the accelerating rate with the additional first power.

19. The virtual vehicle control method according to claim 16, further comprising:
controlling, by the computing device, the virtual vehicle to enter a slipping state when the virtual vehicle is in the throttle held state at the landing moment; and
controlling, by the computing device, the virtual vehicle to move forward with a curtailed power in the slipping state.

20. A virtual vehicle control apparatus, comprising:
a processor;
a control device; and
memory storing computer-readable instructions that, when executed, cause the virtual vehicle control apparatus to:
display a virtual vehicle in a flying state in a virtual environment, the flying state being a state in which the virtual vehicle is not in contact with a ground of the virtual environment;
control the virtual vehicle to change from the flying state to a landing state, the landing state being a state in which the virtual vehicle is in contact with the ground of the virtual environment;
control the virtual vehicle to move forward at a decelerating rate when the virtual vehicle is in a throttle released state at a landing moment of the virtual vehicle, the landing moment being a moment at which the flying state is changed to the landing state; and
within a first duration counted from the landing moment and in response to detecting an operation for charging prior to detecting a first operation for controlling the virtual vehicle to accelerate, control the virtual vehicle to move forward at an accelerating rate with an additional power.
